(19) United States
(12) Patent Application Publication
(10) Pub. No.: US 2016/0325945 A1
(43) Pub. Date: Nov. 10, 2016

(54) DEVICE FOR RECEIVING AND TRANSPORTING A SILICON ROD, AND METHOD FOR PRODUCING POLYCRYSTALLINE SILICON

(71) Applicant: WACKER CHEMIE AG, München (DE)

(72) Inventors: Guenter BERGER, Kirchdorf (DE); Siegfried RIESS, Tarsdorf (AT)

(21) Appl. No.: 15/109,554

(22) PCT Filed: Dec. 11, 2014
(86) PCT No.: PCT/EP2014/077318

§ 371 Date: Jul. 1, 2016

(30) Foreign Application Priority Data
Jan. 7, 2014 (DE) 10 2014 200 058.0

(51) Int. Cl. B65G 47/90; B66C 1/42; C01B 33/035; B65G 47/91

(52) U.S. Cl. CPC B65G 47/902; B65G 47/91; B66C 1/422; B66C 1/425; C01B 33/035

(57) ABSTRACT

A gripping device for the capturing, transporting, and placing of polysilicon rods has an electrically operated rod gripping mechanism actuated by a frame with a parallelogram structure, and two gripping segments engageable with a vertical latch element which engages upon closure and automatically unlatches in an open position. The gripping device reliably extracts and transports polysilicon rods of diverse cross-sections with minimal contamination.

### CROSS REFERENCE TO RELATED APPLICATIONS

This application is the U.S. National Phase of PCT Appln. No. PCT/EP2014/077318 filed Dec. 11, 2014, which claims priority to German Application No. 10 2014 200 058.0 filed Jan. 7, 2014, the disclosures of which are incorporated in their entirety by reference herein.

### BACKGROUND OF THE INVENTION

1 Field of the Invention

The invention relates to a device for extracting and transporting a silicon rod and to a method for producing polycrystalline silicon.

2. Description of the Related Art

Polycrystalline silicon (abbreviated “polysilicon”) is used as the starting material for the production of monocrystalline silicon by means of the Czochralski (CZ) method or by means of the float zone (FZ) method. This monocrystalline silicon is cut into wafers and, after a multiplicity of mechanical, chemical and chemical-mechanical processing operations, is used in the semiconductor industry for the production of electronic components (chips).

In particular, however, polycrystalline silicon is increasingly required for the production of monocrystalline or polycrystalline silicon by means of pulling or casting methods, this monocrystalline or polycrystalline silicon being used for the production of solar cells for photovoltaics.

The polycrystalline silicon is conventionally produced by means of the Siemens process. In this case, thin rods of silicon are heated by direct passage of current in a bell-shaped reactor (“Siemens reactor”) to surface temperatures of 900-1200° C. and a reaction gas comprising a silicon-containing component, in particular halosilane and hydrogen, is introduced through inlet nozzles. The halosilanes are then decomposed on the surface of the thin rods. Elemental silicon is in this case deposited on the thin rods from the vapor phase.

The silicon rods are held in the reactor by special electrodes, which generally consist of highly pure electrographite. In each case, two thin rods with different voltage poling on the electrode holders are connected at the other thin rod end by a bridge to form a closed circuit. Electrical energy for heating the thin rods is supplied via the electrodes and their electrode holders.

During the deposition, the diameter of the thin rods increases. At the same time, the electrode grows into the rod base of the silicon rods, starting at its tip.

Graphite is primarily used as the material for the electrodes, since graphite is available with very high purity and is chemically inert under deposition conditions. Furthermore, graphite has a very low electrical resistivity.

After a desired setpoint diameter of the silicon rods is reached, the deposition process is ended and the incandescent silicon rods are cooled and extracted.

To this end, an extraction aid, as described for example in US 20120237678 A1, may be used. A device for extracting polycrystalline silicon rods comprises a body with outer walls, which is dimensioned in such a way that the rods are enclosed by the outer walls, each outer wall containing a door in order to allow access to at least one of the rods.

After the extraction, the U-shaped polysilicon rod pairs obtained are conventionally cut to length on the electrode and bridge sides, and are crushed into chunks. The crushing is carried out by means of a crusher, for example with a jaw crusher. Such a crusher is described, for example, in EP 338 682 A2. Optionally, pre-crushing is carried out beforehand by means of a hammer.

The extraction of the silicon rod pair from the reactor may be carried out with the aid of a crane device, pulling cables or comparable systems.

CN 102092660 A discloses an electrical lifting vehicle for silicon rods, which comprises an electrical forklift body, the forklift body being provided with a lifting arm, the lifting arm being provided with a plurality of lifting arm holes, and a clamping device especially suitable for silicon rods being connected to the lifting arm holes. The clamping device especially suitable for silicon rods preferably consists of a suspension device and clamping bodies, the clamping bodies having a parallelogram structure, the end point of the upper part of the clamping body being connected to the suspension device, and the two edges of the two sides of the end point of the lower part extending outward and forming a lifting arm.

A problem with this lifting vehicle is that club-shaped, curved, non-round, oval, very short and particularly thick rods cannot be transported reliably. There is furthermore a risk of contamination. The object of the invention is directed to solving these problems.

### SUMMARY OF THE INVENTION

The object of the invention is achieved by a device for extracting and transporting a silicon rod, which is electrically operated and is fastened on a ceiling of a production facility or on a post with a swivel arm, comprising a lifting device with a lifting cylinder and a silicon rod clamping device connected to the lifting cylinder, wherein the clamping device comprises a suspension device for fastening on the lifting cylinder, an articulated arm and a frame with a parallelogram structure and an automatic latch fastened on the articulated arm, as well as a vertical latch element, wherein at least two oval gripper segments are fastened on the frame and wherein the gripper segments and the vertical latch element engage in the closed position of the clamping device and can automatically unlatch in the open position.

### BRIEF DESCRIPTION OF THE DRAWINGS

FIG. 1 shows a device according to the invention.

FIG. 2 shows a side view of FIG. 1.

### DETAILED DESCRIPTION OF THE PREFERRED EMBODIMENTS

Whether fastened on the ceiling or on a post with a swivel arm, the invention provides a vibration-free, freely positionable and reliably displaceable device for taking and transporting a silicon rod. The lifting cylinder is preferably fastened on a cross carriage, which is freely displaceable on the ceiling in the x and y directions.

Preferably, the gripper segments are lined with a hard metal. It is likewise preferred to line the gripper segments with a polymeric plastic. The use of silicon lining is also preferred. Instead of a lining, the gripper segments may also respectively be coated with a corresponding material.

The gripper segments are preferably adjustable. To this end, an articulated arm is provided, by means of which the frame and the gripper segments can be swiveled. In this way, the rods can be taken and transported both horizontally and vertically.

The preferred use of a narrow gripper design even makes it possible to extract and transport rods lying close together without a rod support.

Preferably, all operating elements of the device are coated.

The moving parts are preferably configured with wear-resistant and encapsulated bearing bushes. This has the advantage that no contamination occurs due to wear in the articulation bearing.

Preferably, closed take-up systems with suction devices are provided. These are preferably located under or over the drive elements. In this way, it is possible to avoid contamination due to wear or foreign substances in the drive system.

The clamping device is triggered by the contact plate, by means of which the silicon rod is clamped, or released when placed, by means of a parallelogram frame. Preferably, the clamping device is triggered by means of a radio remote control. The parallelogram structure may, for example, be produced by means of a cross-articulated connection of frame segments.

Preferably, the frame with a parallelogram structure and the gripping segments are formed as latches, each of which can be rotated about a vertical axis extending through the associated carrier arm.

The device is equipped with a double automatic latch, which allows automatic deposition of the rod from the clamping device. The device is preferably configured in such a way that one or more latches engage under the force of the weight of the rod on a suitable part of the device. By raising the gripper, unlatching is carried out and the rod is deposited. Furthermore, besides the frame and the gripper segments, there is a vertical latch element which can be moved from above in the direction of the rod and is likewise engaged and automatically unlatched, when the entire clamping device is raised.

The vertical latch element may be provided with a contact plate, so that the engagement is triggered when the contact plate touches the silicon rod to be taken.

When placing the rod, the contact plate is pressed upward and ensures automatic unlatching.

It has been found that the use of double automatic latches makes it possible to reliably take and transport club-shaped, curved, non-round, oval, very short and thick rods.

The device is freely displaceable and positionable in the x, y and z directions.

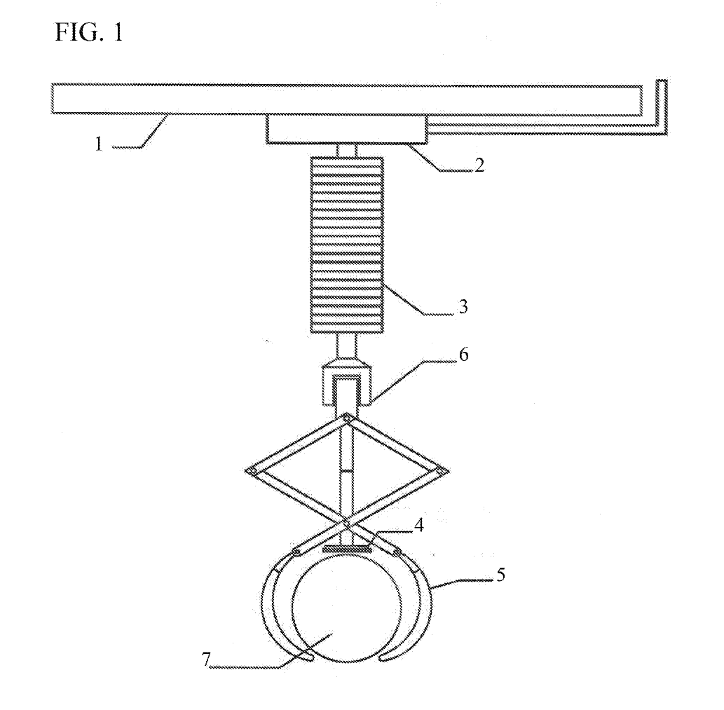

When the rod is intended to be extracted, the device is moved centrally over the rod and then lowered. The clamping device then occupies its open position. As soon as the gripper is lowered to the extent that the gripper segments can grip under the rod, the clamping device is swiveled from its open position into its closed position (cf. FIG. 1).

By virtue of the grippers, which are provided with a low-contamination material for silicon, ideally only as much force as is required for reliable transport is exerted on the silicon rod. In this way, damage to the rod is almost entirely ruled out.

The working reliability during the transport process is increased. This applies in particular to any rod fracture (for example porous, cracked and unstable rods).

The preferred use of a radio remote control also contributes to increased working reliability.

The coating of the gripper segments ensures low-contamination transport of the silicon rods, which is of great importance for the product quality.

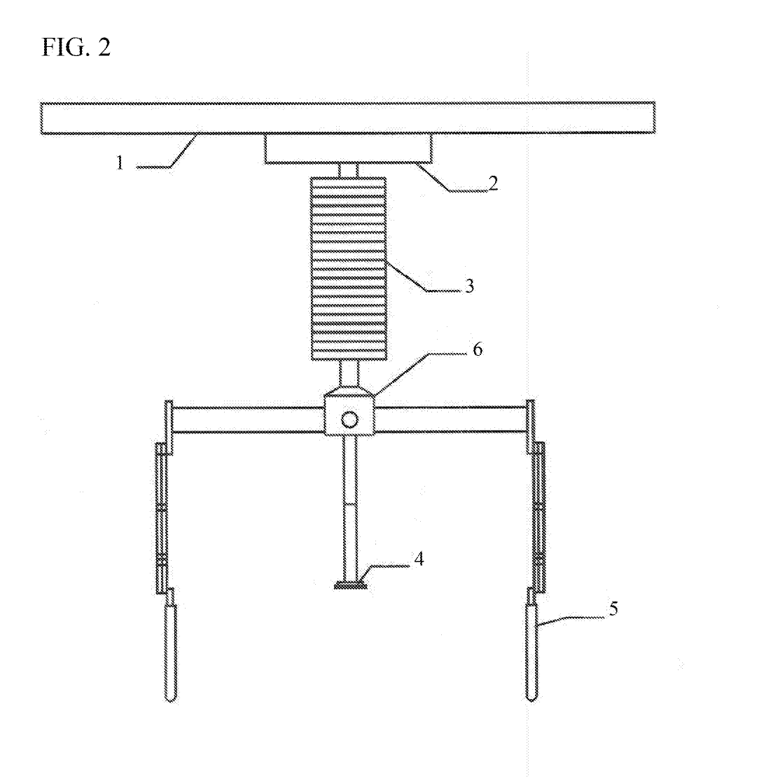

The invention will also be explained below with the aid of FIGS. 1 and 2.

### LIST OF REFERENCES USED

1 ceiling
2 cross carriage
3 lifting cylinder
4 element for double automatic latch
5 gripper segments
6 articulated arm
7 rod

FIG. 1 schematically shows a device, in which a cross carriage 2 is fastened on the ceiling 1 of a production hall.

The cross carriage is connected to the lifting cylinder 3.

With the device, a rod 7 is extracted and clamped by means of gripper segments 5.

FIG. 2 shows a side view of FIG. 1.

By means of the articulated arm 6, the frame and the gripper segment 5 can be swiveled.

A vertical element for the double automatic latch 4 is provided.

The invention relates to a device with which a silicon rod can be extracted, clamped, transported to another workstation and reliably placed there.

Before the silicon rods are crushed into chunks, one or more such processes of extracting, transport and placing are necessary.

The starting point is the deposition of polycrystalline silicon by means of CVD on at least one U-shaped carrier body, which is heated by direct passage of current to a temperature at which polycrystalline silicon is deposited on the carrier body, so that at least one U-shaped polycrystalline silicon rod pair is formed, the carrier body being connected to a graphite electrode at each of its free ends and thereby being supplied with current.

After the deposition, the at least one polycrystalline silicon rod pair must be removed from the reactor. A body with an outer wall and an inner wall, by which the silicon rod pair is fully enclosed, is suitable for this, the body together with the silicon rod pair enclosed by it being removed from the reactor. Cranes, pulling cables or the like are suitable for removing the body and the silicon rod pair. It is however also possible to use a device according to the invention, which is particularly preferred.

After the removal of the silicon rod pairs from the reactor, it is usual to transport it to a separate workstation at which the graphite residues are removed from the electrode-side ends of the at least two polycrystalline silicon rods of the at least one polycrystalline silicon rod pair, and to cut the silicon rod pair to length at the non-electrode-side ends (the bridge side), so that two polycrystalline silicon rods are obtained.

It is preferred to use a device according to the invention for the transport from the reactor to this workstation.

As soon as the graphite residues have been removed from the silicon rods and the bridges, it is usual to transport the silicon rods to another workstation, where they are crushed into chunks by means of suitable crushing tools. Hammers are suitable for pre-crushing, and jaw or roll crushers are preferably used for crushing into particular chunk size classes.

After the removal of the bridges and graphite residues, it is preferred to capture the silicon rods by means of a device according to the invention, and transport them to the workstation with the crushing tool or the crushing installation, and place them there on a working table or in an installation.

1.-9. (canceled)

10. A device for transporting a silicon rod, the device being electrically operated and fastened on a ceiling of a production facility or on a post with a swivel arm, comprising a lifter with a lifting cylinder and a silicon rod clamp connected to the lifting cylinder, wherein the clamp comprises a suspension fastened to the lifting cylinder, an articulated arm and a frame with a parallelogram structure, an automatic latch fastened on the articulated arm, and a vertical latch element, wherein at least two oval gripper segments are fastened on the frame and wherein the gripper segments and the vertical latch element engage in a closed position of the clamp and automatically unlatch in an open position.

11. The device of claim 10, wherein the lifting cylinder is fastened on a cross carriage located on the ceiling of the production facility, and the cross carriage is freely displaceable on the ceiling in an x and a y direction.

12. The device of claim 10, wherein the gripper segments are lined or coated with a hard metal, with a polymeric plastic, with silicon, or combinations thereof.

13. The device of claim 10, wherein the frame and the gripper segments can be swiveled by the articulated arm.

14. The device of claim 10, wherein all moving parts are configured with wear-resistant and encapsulated bearing bushes.

15. The device of claim 10, wherein at least one closed take-up system with a suction device is provided, located under or over the lifting cylinder or an optionally provided cross carriage.

16. A method for the processing of a polysilicon rod, comprising extracting a silicon rod by means of a device of claim 10, clamped by means of the clamp, transported to a workstation, and placed there.

17. A method for producing polycrystalline silicon, comprising:
a) depositing polycrystalline silicon by means of CVD on at least one U-shaped carrier body heated by direct passage of current to a temperature at which polycrystalline silicon is deposited on the carrier body, so that at least one U-shaped polycrystalline silicon rod pair is formed, the carrier body being connected to a graphite electrode at each of its free ends and thereby being supplied with current;
b) extracting the at least one polycrystalline silicon rod pair from the reactor;
c) removing the graphite residues from the ends of the at least two polycrystalline silicon rods of the at least one polycrystalline silicon rod pair, and cutting the silicon rod pair to length, so that two separate polycrystalline silicon rods formed; and
d) crushing a polycrystalline silicon rod into chunks by means of crushing tools; wherein, after step c), a polycrystalline silicon rod is extracted by means of a device of claim 10 and transported to an installation in which the silicon rod is crushed into chunks according to step d).

18. The method of claim 17, wherein the extracting of the at least one polycrystalline silicon rod pair from the reactor is carried out by means of a body having an outer wall and an inner wall which fully enclose the silicon rod pair, wherein the body together with the silicon rod pair is removed from the reactor by means of a device of claim 10 and transported to a workstation, at which according to step c) graphite residues are removed and the silicon rod pairs are cut to length.
